(19) United States
(12) Patent Application Publication
(10) Pub. No.: US 2018/0268278 A1
(43) Pub. Date: Sep. 20, 2018

(54) SYSTEM AND METHOD FOR SCREEN PANEL TRACKING

(71) Applicant: Aqseptence Group Pty Ltd., Geebung ,QLD (AU)

(72) Inventors: Warren Anthony SPINKS, Warners Bay (AU); Steven Paul COLEMAN, Windaroo (AU)

(73) Assignee: Aqseptence Group Pty Ltd., Geebung, QLD (AU)

(21) Appl. No.: 15/516,573

(22) PCT Filed: Oct. 5, 2015
(86) PCT No.: PCT/US2015/053997

§ 371 Date: Apr. 3, 2017

Related U.S. Application Data
(60) Provisional application No. 62/059,268, filed on Oct. 3, 2014.

(51) Int. Cl. G06K 19/077; B07B 1/46; G06K 19/04

(52) U.S. Cl. CPC G06K 19/07758; B07B 1/4645; G06K 2017/0045; B07B 1/4627; G06K 19/04

(57) ABSTRACT

A screen assembly may include a frame defining an aperture, a screen panel disposed within the aperture, the screen panel having a plurality of slots formed therethrough that extend between top and bottom surfaces of the screen panel, and an RFID tag disposed within a recess formed in an edge of the screen panel, the edge being between the top and bottom surfaces.

### CROSS-REFERENCE TO PRIORITY APPLICATION

This application claims the benefit of U.S. Patent Application Ser. No. 62/059,268 entitled “System and Method for Screen Panel Tracking” (filed Oct. 3, 2014), which is hereby incorporated by reference in its entirety.

### FIELD

The disclosure relates generally to the field of screening systems, and more particularly to a screen panel having an integrated RFID tag for facilitating tracking and wear monitoring.

### BACKGROUND

Screening systems having replaceable screen panels are commonly used in mining processes for multiple purposes relating to mineral processing, handling, treatment and beneficiation. For example, a plurality of screen panels may be disposed within a flat frame in a two-dimensional grid configuration. A coal slurry may be poured or flowed over the screen panels while the screen panels are mechanically vibrated. Water and fines in the coal slurry may fall by gravity through slots or apertures in the screen panels while coal pieces that are too large to fit through the slots remain on top surfaces of the screen panels where they can be collected. The size of coal pieces that are retained by the screen panels therefore depends on the sizes of the slots in the screen panels. As such, the panels are carefully designed and manufactured to maintain precise slot sizes.

Over time, screen panels are subject to wear and must eventually be replaced. For example, due to the abrasive nature of coal slurry, the slots in a screen panel may become enlarged, resulting in coal pieces larger than a desired minimum size being passed through the slots. The yield of a screen panel that has experienced significant wear may therefore become highly degraded. However, while a worn screen panel may become unsuitable for a particular application, that screen panel may still be suitable for use in another application (e.g., in another screening machine or another location in the same screen) wherein the enlarged slots of the screen panel are acceptable.

When a screen panel is installed or moved from one application to another, service personnel may manually record identifying information (e.g. an ID number) associated with the screen panel, along with the date of installation or move. Additionally, in order to determine whether a screen panel is approaching the end of its useful life in particular application and whether the screen panel may be suitable for use in another application, service personnel periodically measure and record the sizes of slots in screen panels. These measurements are manually recorded along with the identifying information of the corresponding screen panels. The recorded measurements may be used to determine how quickly each screen panel is accumulating wear over time, thereby allowing service personnel to forecast when each screen panel should be replaced and/or moved to a different application.

Manually recording screen panel relocation data and wear data in the manner described above is associated with a number of shortcomings. For example, due to the abrasive operating environment in which screen panels are used, it is common for identifying information on screen panels to wear off over time, sometimes within hours, making it difficult or impossible to track a particular screen panel. Warranty claims regarding the performance of screen panels are therefore open to conjecture, as it may be impossible to tell when a particular screen panel was produced or sold, when it was installed, and how long it was in use. Additionally, if service personnel are not vigilant with regard to recording a panel's date of installation and the dates on which the panel is moved from one application to another, it is easy to lose track of a panel's location and operational history.

In view of the forgoing, it would be advantageous to provide a convenient, reliable way to track the movement and operational history of individual screen panels in a manner that is less susceptible to operational wear and to the negligence of service personnel relative to traditional tracking and monitoring methods.

### BRIEF SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments of the present disclosure are generally directed to a screen assembly having a screen panel that can be easily and reliably tracked, and a method for monitoring and forecasting wear on such a screen panel.

In one aspect, the present invention embraces an apparatus for screen panel tracking and wear monitoring may include: a screen panel, the screen panel comprising a plurality of slots formed therethrough that extend between a top surface and a bottom surface of the screen panel; and an RFID tag assembly, the RFID tag assembly comprising an RFID tag and a first insulating material that completely encapsulates the RFID tag, wherein the RFID tag assembly is at least partially embedded within the screen panel, wherein the RFID tag comprises a unique screen panel identifier associated with the screen panel.

In some embodiments and in combination with any of the above embodiment, the screen panel comprises a second insulating material, wherein the RFID tag assembly is completely encapsulated within the second insulating material.

In some embodiments and in combination with any of the above embodiments, the first insulating material and the second insulating material are formed from the same material.

In some embodiments and in combination with any of the above embodiments, the RFID tag assembly is configured to withstand a temperature of at least about 140 degrees Celsius.

In some embodiments and in combination with any of the above embodiments, the first insulating material is a polymer.

In some embodiments and in combination with any of the above embodiments, the first insulating material is a polyurethane.

In some embodiments and in combination with any of the above embodiments, the RFID tag is disposed within a recess formed in an edge of the screen panel, the edge being disposed between the top and bottom surfaces, wherein the screen panel further comprises a cap, the cap being fixed to an outlet defined by the recess.

In some embodiments and in combination with any of the above embodiments, the apparatus further comprises a frame defining an aperture, wherein the screen panel is disposed within the aperture.

In some embodiments and in combination with any of the above embodiments, a system for monitoring and forecasting wear on a screen assembly may include: the apparatus disclosed above; an analysis system comprising: a memory; a processor; a database stored in the memory, the database including compiled information regarding the screen panel, the compiled information including a measured size of a slot in the screen panel, a date upon which the measured size was taken, and a digital image of the screen panel; and a module stored in the memory, executable by the at least one processor and configured to: (i) receive the unique screen panel identifier associated with the screen panel and (ii) correlate the compiled information with the unique screen panel identifier associated with the screen panel.

In another aspect, and in combination with any of the above embodiments, the present invention embraces a method for manufacturing an apparatus for screen panel tracking and wear monitoring that includes: providing an RFID tag, wherein the wherein the RFID tag is configured to store a unique screen panel identifier associated with the screen panel; encapsulating the RFID tag with a first insulating material such that the first insulating material completely encapsulates the RFID tag, wherein the RFID tag and the first insulating material define a RFID tag assembly; and disposing the RFID tag assembly within the screen panel such that the RFID tag assembly is at least partially embedded within the screen panel, wherein the screen panel comprises a plurality of slots formed therethrough that extend between a top surface and a bottom surface of the screen panel.

In some embodiments and in combination with any of the above embodiments, encapsulating the RFID tag with an insulating material further comprises: providing a first mold; disposing the RFID tag within the mold; pouring the first insulating material into the mold such that the first insulating material completely encapsulates the RFID tag; and extracting the RFID tag assembly from the first mold.

In some embodiments and in combination with any of any of the above embodiments, disposing the RFID tag within the screen panel further comprises: providing a second mold configured mold at least a portion of the screen panel; disposing the RFID tag assembly in an interior of the second mold; bonding at least a portion of a surface of the RFID tag assembly and the interior of the second mold; and pouring a second insulating material into the mold to produce the screen panel, such that the RFID tag assembly is at least partially embedded within the second insulating material.

In some embodiments and in combination with any of the above embodiments, disposing the RFID tag within the screen panel further comprises: providing the screen panel; providing a recess on an edge of the screen panel, the edge being between the top and bottom surfaces; disposing the RFID tag assembly within the recess such that at least a portion of the RFID tag is embedded in the screen panel; providing a cap; and affixing the cap to an outlet defined by the recess.

In yet another aspect, and in combination with any of the above embodiments, the present invention embraces a method for monitoring and forecasting wear on a screen panel that includes: providing a screen panel, the screen panel comprising an RFID tag assembly that includes an RFID tag encapsulated in a first insulating material, wherein the RFID tag assembly is at least partially embedded within the screen panel, wherein a unique screen panel identifier associated with the screen panel is stored in the RFID tag; determining a measurement of a size of a slot in the screen panel; reading the unique screen panel identifier stored in the RFID tag; recording the unique screen panel identifier, the measurement, and a date on which the measurement is determined in a database of information; and analyzing the database of information to make a determination relating to an operational lifespan of the screen panel.

In some embodiments and in combination with any of the above embodiments, the method for monitoring and forecasting wear on a screen panel further comprises moving the screen panel from a first location to a second location in a processing plant based on making the determination relating to an operational lifespan of the screen panel.

In some embodiments and in combination with any of the above embodiments, the method for monitoring and forecasting wear on a screen panel further comprises discarding the screen panel based on making the determination relating to an operational lifespan of the screen panel.

In another aspect, and in combination with any of the above embodiments, the present invention embraces a screen assembly that may include: a frame defining an aperture, a screen panel disposed within the aperture, the screen panel having a plurality of slots formed therethrough that extend between top and bottom surfaces of the screen panel, and an RFID tag disposed within a recess formed in an edge of the screen panel, the edge being between the top and bottom surfaces, the RFID tag including panel identification information. The assembly may further include an analysis system including a database, the database including compiled information regarding the screen panel, the compiled information include a measured size of a slot in the screen panel, a date upon which the measured size was taken, and a digital image of the screen panel. The analysis system can be configured to correlate the compiled information with the panel identification information read from the RFID tag.

In another aspect, and in combination with any of the above embodiments, the present invention embraces a method for monitoring and forecasting wear on a screen panel that may include: measuring of a size of a slot in the screen panel, reading identifying information stored in an RFID tag of the screen panel, recording the identifying information, the measurement, and a date on which the measurement is performed, repeating the steps of measuring, reading, and recording to compile a database of information, and analyzing the database of information to make a determination relating to an operational lifespan of the screen panel.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

For a more complete understanding, reference should now be had to the embodiments shown in the accompanying drawings and described below. In the drawings:

FIG. 1 is a top view illustrating a screen assembly in accordance with one embodiment of the present disclosure.

FIG. 2a is perspective view illustrating an RFID tag assembly in accordance with another embodiment of the invention.

FIG. 2b is an exploded view of the RFID tag assembly of the embodiment illustrated in FIG. 2a.

FIG. 3a is a perspective view illustrating an RFID tag assembly and related portions of a screen panel in accordance with another embodiment of the invention.

FIG. 3b is a sectional view illustrating the RFID tag assembly and related portions of a screen panel in accordance with the embodiment of FIG. 3a.

FIG. 4 is detail view illustrating an RFID tag and related portions of a screen panel in accordance with another embodiment of the invention.

FIG. 5 is a flow diagram illustrating an exemplary method for tracking and monitoring wear on a screen panel in accordance with the present disclosure.

FIG. 6 illustrates is a sample screen panel wear report in accordance with the present disclosure.

FIG. 7 illustrates is a system environment for monitoring and forecasting wear of a plurality of screen panels in a processing plant.

### DETAILED DESCRIPTION

The present system and method will now be described more fully hereinafter with reference to the accompanying drawings, in which preferred embodiments are shown. The system and method may, however, be embodied in many different forms and should not be construed as being limited to the embodiments set forth herein. Rather, these embodiments are provided so that this disclosure will be thorough and complete, and will fully convey the scope of the system and method to those skilled in the art. In the drawings, like numbers refer to like elements throughout.

Certain terminology is used herein for convenience only and is not to be taken as a limitation on the embodiments described. For example, words such as “top”, “bottom”, ^{“}upper,” “lower,” “left,” “right,” “horizontal,” “vertical,” “upward,” and “downward” merely describe the configuration shown in the figures or the orientation of a part in the installed position. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first.

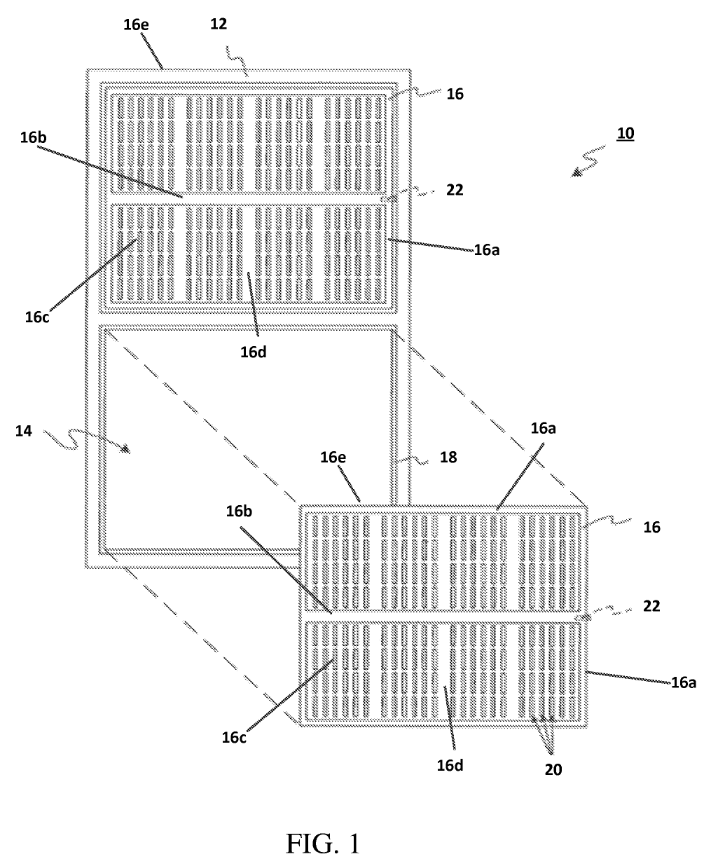

Referring now to FIG. 1, a screen assembly 10 in accordance with an exemplary embodiment of the present disclosure is shown. The screen assembly 10 may include a rigid frame 12 that may be formed of any sufficiently durable material that is resistant to excessive deformation and wear, including, but not limited to, various metals, plastics, or composites. The frame 12 may define one or more apertures or openings 14 for receiving corresponding screen panels 16. One of the screen panels 16 is shown removed from the frame 12 in FIG. 1 for purposes of illustration. The frame 12 may be adapted to be securely mounted to one or more rails (not shown) along with a plurality of similar frames (and their respective screen panels) to define a grid-like arrangement of screen assemblies upon which process substances can be deposited to separate the substances into one or more components. The process substances may comprise fluids, solid mixtures, slurries, colloids, suspensions, a combination of the above or any other substances that need to be separated into or more components. For example, the screen panels may be utilized to separate a substantially solid mixture into one or more components similar to a sieve or the screen panels may be configured to dewater a slurry similar to a filtration process. The screen panels 16 may be secured or fastened to the frame 12 by any other suitable means known in the art. Typically, the screen panels 16 are removably fastened or secured to the frame so that the screen panels 16 may be interchanged or replaced at various stages of operation, although the screen panels 16 may be permanently secured to the frame 12 when required by certain applications. The screen panels 16 may be removably secured to the frame 12, such as by friction fit, snap fit, mechanical fasteners, etc. While the frame 12 is illustrated with two screen panels 16, more or fewer screen panels may be utilized based on the application. In some embodiments, the frame 12 is a part of processing equipment or devices configured to control the frame 12 and/or the screen panels 16 by providing vibratory motion, inclination, rotary motion, translation or other forms of impetus required for filtering the process substances.

In some embodiments, the screen panels 16, may be utilized without the frame 12. In this regard, the screen panels may be used individually or a plurality of screen panels 12 may be arranged/connected to form a screen assembly by any suitable means. For example, certain sides of the screen panels may be configured to receive complementary sides of adjacent screen panels. As another example, the screen panels may be removably fastened using bolts, nuts, hinges, ropes or permanently fastened by welding, brazing, using rivets or any other fastening/securing means known in the art.

The screen panels 16 may comprise a top surface 16d and a bottom surface 16e. The top surface 16d and a bottom surface 16e may be parallel curved/straight planes or may be oriented at an angle with respect to each other. The perpendicular distance between the top and bottom surfaces may indicate the depth of the screen panel 16. The screen panels 16 may comprise a framework 16a comprising one or more sides, disposed between the top and bottom surfaces. The contour of the framework 16a may be polygonal (for example, rectangular), circular, elliptical, curvilinear or a combination of suitable shapes. The framework 16a may form at least a portion or the entire perimeter of the screen panel 16 and provide structural stability to the screen panel 16. The one or more sides may comprise coupling features that enable the screen panel 16 to be coupled to the frame 12, an adjacent screen panel 16 or another structure. For example, the coupling features may be configured to connect two adjacent screen panels 16 with a snap fit. As another example, the screen panels 16 may be seated within the apertures 14 of the frame 12, such as upon inwardly-extending, vertically-recessed shoulders 18 that surround the apertures 14.

Furthermore, the screen panels 16 may comprise one or more bars or ribs 16b disposed between the top and bottom surfaces. The bars 16b may be linear or curved. The ends of the bars 16b may be connected to the framework 16a or other bars 16b, thereby providing additional structural support. The one or more bars 16b may be arranged parallel to each other, may be oriented at any suitable angle or may intersect one another. The depth and thickness of the bars may be similar to/different from the depth and thickness of the framework 16a. The screen panels 16 may further comprise one or more screen or filter portions 16c. The screen portions 16c may be substantially planar members, positioned between the top and bottom surfaces. The perimeters of the screen portions 16c may be at least partially surrounded by the framework 16a, the bars 16b or a combination of both. Typically, the screen portions 16c further comprise a plurality of slots, apertures or slots 20 extending therethrough. The screen portions 16c may be constructed out of wires, plates, meshes comprising perforations, slots or openings or other configurations of appropriate shapes and sizes suitable for separating the process substances into one or more components. In some embodiments, the framework 16a and/or the bars 16b may also comprise slots 20.

The screen panels 16 may be manufactured with similar materials as the frame 12 or the screen panels may be constructed out of different materials. In some embodiments, the screen panels 16 may comprise different materials or portions of the screen panels 16 may be constructed out of different materials. For example, the framework 16a may be constructed out of a different material than the screen portions 16c and/or the rods 16b. In this regard, the screen panels may be constructed out of materials such as stainless steel, carbon steels, suitable metals, alloys, plastics, composites, natural or synthetic materials, polymers and the like. The materials may be chosen for the specific application based on their durability, strength, ductility/malleability, weight, rigidity/flexibility, operative temperature ranges, durability, resistance to fatigue and creep, magnetic properties and the like. Furthermore, based on the application, the materials may be chosen for their corrosion resistance and chemical stability. In one non-limiting embodiment, the screen panels 16 may be formed of a resilient polymer such as polyurethane. Other synthetic or naturally occurring polymers (For example, silicones, nitriles and the like) may be chosen based on their thermosetting, thermoplastic properties, ability to be molded/cast, ability to withstand metallic and/or electromagnetic interference and noise and the like. In other non-limiting embodiments, the screen panels 16 may be formed of metal wire mesh, slot metal plate, punched or molded rubber, or the like. Typically, at least a portion of the screen panels are formed from insulating material. As described previously, the screen panels 16 may define a plurality of slots or apertures 20, through which, one or more components of the process substance are allowed to pass through. For example, during dewatering of a coal slurry, water and fines in the slurry are allowed to pass through the screen panels 16 while coal pieces are retained on the top surfaces of the screen panels 16. The particular sizes and shapes of the slots 20 may be selected based on a desired minimum size of components coal pieces that are to be retained by the screen panels 16. Thus, if the slots 20 are too large, or become too large due to wear of the screen panels 16 over time, too coal pieces that are larger than a predetermined minimum size may be allowed to pass through the screen panels 16 resulting in reduced coal yield. Although the invention is described with respect to coal processing as an example in this disclosure, it is understood that the invention is applicable in other industries as well. In this regard the present invention finds applications in in processes/industries that require separating a process substance into one or more components, for example, sugar processing, coal mining, petroleum refining, cement manufacturing, meat processing, and the like.

Each of the screen panels 16 may further include one or more radio frequency identification (RFID) tags 22 installed therein. Each RFID tag 22 may contain a screen panel identifier (ID) that designates unique identifying information for each screen, such as a unique number or code, which can be read by an appropriately configured RFID reader. The RFID tag 22 is illustrated as being partially enclosed (for example, embedded) by the screen panel, however the RFID tag may be completely enclosed as well. The RFID tag 22 may be positioned along the framework 16a, along one or more bars 16b, along the screen portion 16c, or at the intersections/junctions of the preceding portions of the screen panel 16. In some embodiments, the RFID tag 22, is disposed along a portion of the screen with maximum volume of material, for example at the intersection of the framework 16a and the bar 16b as illustrated by FIG. 1. In some embodiments, the RFID tag 22 is positioned along the framework 16a or closer to the perimeter, for ease of access, as illustrated by FIG. 1 although the RFID tag 22 may be placed towards the center. Typically a plurality of panels are employed for processing during operation. To minimize inadvertent confusion for the operator or the automated system associated with remitting or retrieving data from the RFID tag 22 with a portable RFID reader, in some embodiments, the RFID tag 22 associated with each of the plurality of screen panels 16 is placed at the same position.

Furthermore, the RFID tag 22 may be disposed between the top surface and the bottom surface, at the top surface or at the bottom surface. An axis of the RFID tag 22, extending from an antenna 22a to a chip 22b and/or a cap 26, may be oriented along any suitable direction, i.e. at any suitable angle with respect to the framework 16a, one or more bars 16b and/or the top and bottom surfaces. In this regard, FIG. 1 illustrates the RFID tag 22 being oriented parallel to the top and bottom surfaces and perpendicular to a side of the framework 16a. The installation of the RFID tag 22 in the screen panel 16 is described in detail below with respect to several embodiments of the invention. It is understood that the embodiment described above may be combined with other embodiments described elsewhere in the disclosure and vice versa. For example, a RFID tag assembly 30 (described below) may be utilized in place of the RFID tag 22.

RFID tags are devices configured to store data and transmit the data over a wireless communication channel. RFID tags may utilize electromagnetic fields to transfer data. For example, the RFID tags may communicate with a compatible RFID reader via radio waves through near field communication. The RFID tags may be configured to communicate over low frequency bands (120-150 kHz), high frequency bands (13.56 MHz), ultra-high frequency bands (433 MHz, 865-925 MHz) or microwave bands (2450-5000 MHz, 3.1-10 GHz) based on the application. Furthermore the RFID tags 22 may communicate over ranges of distances of 10 cm-2 m, 100 m-200 m and the like. The RFID tags 22 may be chosen from passive, active or battery-assisted passive RFID tags. In this regard, each type of RFID tag may be associated with a type of RFID reader, or a single RFID reader may be configured to communicate with multiple types of RFID tags 22. In some embodiments, each of the RFID tags 22 is associated with a screen panel and the RFID tags comprise a unique screen panel identifiers correlated with particular screen panel, and so the RFID system design can discriminate among several RFID tags that might be within the range of the RFID reader and read them simultaneously. While in other embodiments, for example in the cases with RFID tags 22 comprising low ranges of transmission distances, the RFID reader may communicate with each RFID tag 22 individually. In some embodiments, the RFID tags may comprise an integrated circuit or chip 22b with non-volatile memory to store data and an antenna 22a, with (for example, active RFID tags and battery-assisted passive RFID tags) or without (for example, passive RFID tags) a battery. Active tags, typically, comprise a battery and may intermittently transmit data, while battery-assisted passive tags may comprise a battery that is only activated in the presence of an RFID reader. Typically, passive tags do not comprise a battery and rely on an electromagnetic field generated/or electromagnetic energy transmitted by the RFID reader to cause a voltage in the antenna coil in the tag and charge a capacitor, so that the RFID tag can be powered to transmit and receive data.

In some embodiments, passive RFID tags are installed in the screen panel 16, although active RFID tags may also be utilized. In some embodiments, Half Duplex (HDX) tags are utilized. Half duplex tags can receive and transmit data; however, typically communication occurs only in one direction at a time. Half Duplex tags are advantageous since they utilize lesser energy, provide better noise immunity and enable the use of simpler antennas. Furthermore, utilizing low frequency HDX tags enables the RFID tag to be used in a wide variety of environments, comprising solids and fluids, since unlike high frequency waves, low frequency waves can be conducted through different mediums without significant absorption or reflection. In some embodiments, ultra-high frequency tags may be utilized when the RFID tags are required to transmit over larger areas. In some embodiments, Full Duplex (FDX) tags may be utilized. Full Duplex tags are able to receive and transmit data simultaneously. In some embodiments, the screen panel 16 and or the screen assembly 10 comprise one or more RFID tags described above, either only one kind or a combination.

Typically, the screen panels 16 and hence the RFID tags 22 are subjected to harsh operating conditions during use in various applications. In some applications, the RFID tags may need to withstand temperatures of at least about 140 degrees Celsius, while in other applications the RFID tags 22 may be required to function at temperatures of at least about 150 degrees Celsius. Furthermore, the RFID tags are subjected to extreme vibrations and forces that are about 6 times the gravitational force. A conventional RFID tag merely placed on or secured to a panel might not be able to endure the operating conditions described above, due to abrasion, corrosion and other factors. In this regard, the intense temperatures and forces might damage the RFID tag, cause the dislodgment of the RFID tag, and, therefore, render the RFID tag inoperable. Moreover, the presence of metals and other conducting materials in the screen panels 16 themselves, the frame 12, in the surrounding equipment/machinery and/or in the process substances being handled impede the functioning of the RFID tags due to metallic noise and interference with electromagnetic waves. These materials alter the electromagnetic field that the RFID tag and reader negate the signals and therefore make the tags unreadable. In this regard, reflection of the signals may also occur. The present invention alleviates the above problems by enabling utilization of RFID tags in challenging environments while effectively securing the RFID tag to prevent dislodgement. In some embodiments, Half Duplex tags are utilized to overcome metallic noise and interference since Half duplex tags provide better noise resistance/immunity as described previously. In addition, the RFID tag may be encapsulated in an insulating material, and the encapsulated RFID tag may be embedded in the screen panel, to not only shield the RFID tag from high temperatures and forces, but also to help mitigate the effects of metallic noise and interference.

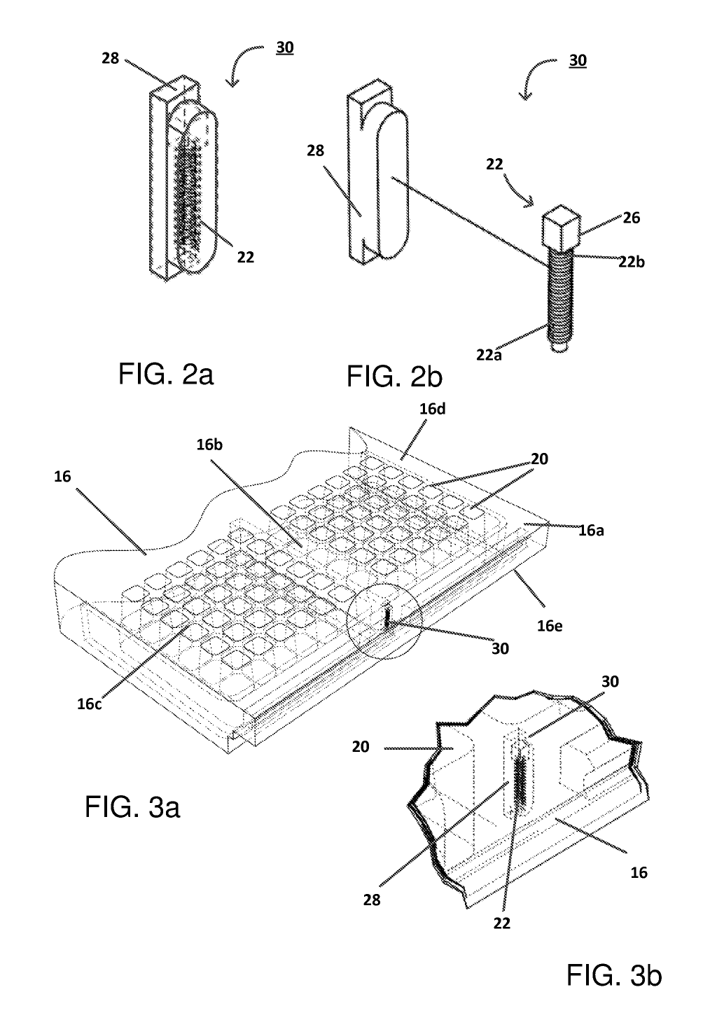

In this regard, the RFID tag 22 may be at least partially encased in an insulating material 28 as illustrated by FIG. 2a. The RFID tag 22, together with the insulating material 28 may be referred to as the RFID tag assembly 30. FIG. 2b illustrates the exploded view of the RFID tag assembly 30, with the components separated for clarity. Although illustrated as being substantially cylindrical, the RFID tag 22 may be of any suitable shape. In some embodiments, the insulating material comprises urethane or polyurethane material. The insulating material may comprise synthetic or naturally occurring polymers, silicones, nitriles, epoxy compounds, resins, rubber and the like, in other embodiments. Other suitable materials, plastics, gels, coatings, mineral compounds may be chosen as the insulating materials based on their thermosetting, thermoplastic properties, ability to be molded/cast, ability to withstand metallic and/or electromagnetic interference and noise, ability to withstand high temperatures without melting/vaporizing, formability, or other relevant properties based on the application. The RFID tag 22 may be encapsulated/encased by a combination of insulating materials, with each material encased a portion of the exterior of the RFID tag 22. The RFID tag 22 may be at least partially encased in the insulating material 28, although typically, the RFID tag is fully encapsulated and secured on all external surfaces to the insulating material for adequate protection and shielding as illustrated in FIG. 2a. The RFID tag 22 may be encased by the insulating material by molding/casting the insulating material around the RFID tag 22, depositing the insulating material on the external surface of the RFID tag, adsorption, coatings, gluing pre-formed portions of the insulating material to the RFID tag or any other means known in the art. For example, the insulating material may be molded or cast to encapsulate the RFID tag 22. In this regard, a mold comprising one or more parts (for example, cope and drag halves) may be provided. The mold may define a mold cavity on the interior, the cavity comprising one or more walls. The mold cavity may be of any suitable shape and may be sized such that the insulating material extends for a predetermined thickness around the RFID tag 22 after setting. The thickness may be uniform or may vary across various contours of the RFID tag assembly 30. The RFID tag 22 may be placed in the mold cavity such that the one or more walls partially or fully surround the tag 22. The insulated material is then poured to completely encapsulate the RFID tag 22 and allowed to set/cure. In some embodiments, at least a portion of insulated material may be provided in the mold before placing the RFID tag 22, and the RFID tag 22 may be placed on the portion of the insulated material prior to pouring. The RFID tag assembly 30 is then extracted from the mold.

Now, referring to FIG. 3a, illustrating an RFID tag assembly 30 installed in a screen panel in accordance with one embodiment of the invention. The portions enclosed by the broken lines in the screen panel 16 of FIG. 3a depict recesses in the screen panel, for example the slots 20. Other portions enclosed by the broken lines may refer to, in some embodiments, one or more support structures encased/located in the screen panel 16. In accordance with a typical embodiment, FIGS. 3a-3b illustrates a RFID tag assembly 30 being completely enclosed within the screen panel 16. However, the RFID tag assembly 30 may be partially enclosed by the screen panel 16, may be bonded to a surface of the screen panel 16 or may be secured to the screen panel 16 in any suitable method so as to ensure that the RFID assembly 30 does not dislodge during operation. Furthermore, similar to the embodiment described with respect to FIG. 1, the RFID tag assembly 30 may be placed at any suitable position in or around the screen panel 16, and may be suitably oriented. In this regard, for the purposes of illustration and not limitation, FIG. 3a, illustrates the RFID tag assembly 30 being oriented perpendicular to the top and bottom surfaces (16d, 16e) and positioned at the intersection of the framework 16a and the bar 16b. Typically, the RFID tag assembly 30 (or the RFID tag 22) is colored to match the color of the portion of the screen panel 16 in which the RFID tag assembly 30 (or the RFID tag 22) is embedded or otherwise secured. The RFID tag assembly 30 may be installed in the screen panel 16 by any suitable means, however, a casting method is described below. In this regard, a panel mold comprising one or more parts may be constructed. In some embodiments, one or more portions of the screen panel 16 may be cast separately and assembled. For example, the framework 16a and the one or more bars 16b may be cast together to form a first casting, and the screen portions 16c may be cast individually to form one or more second castings and then the first and second castings may be assembled to form the screen panel 16. In this regard, RFID tag assemblies 30 may be placed in the molds associated with the first and/or second castings and embedded within the respective casting before assembly. Alternatively, the screen panel may be cast as a single component, albeit, in some embodiments, additional support structures and the like may be placed into the mold cavity before pouring the screen panel material, to strengthen the finished casting. These support structures may be embedded in the casting or they may be removable after extracting the screen panel 16 from the mold. The support structures may comprise the same or different materials as the rest of the screen panel casting, discussed previously in the disclosure. For example, the screen panel material may be polyurethane or other polymers while the support structures might comprise a metal. By the virtue of encapsulating the RFID tag 22 in the insulating material, the interference caused by the metal support structures on the components and communication of the RFID tags 22 may be minimal.

To create the screen panel, a panel mold comprising one or more parts may be constructed. The panel mold may define a panel mold cavity on the interior, the cavity comprising an interior surface. The panel mold cavity is typically shaped to produce a desired contour of the screen panel. The RFID tag assembly 30 may be placed in the interior of the mold cavity. In some embodiments, at least a portion of the external surface of the RFID tag assembly 30 is bonded or removably fastened to the interior surface of the panel mold cavity. In some embodiments, at least a portion of the external surface of the RFID tag assembly 30 is bonded or suitably fastened to a support structure in the interior of the panel mold cavity. The screen panel material is then poured to completely or partially encapsulate the RFID tag assembly 30 and form the screen panel 16. In some embodiments, the screen panel material is molten and poured at a high temperature. The encapsulation by the insulating material protects the RFID tag 22 from any detrimental heat. The apparatus is then allowed to set/cure. Although illustrated by a casting process, this invention is applicable for screen panels that are not cast. For example, the screen panel 16 may comprise one or more sections, formed by means known in the art, and the sections may be suitably glued/fastened around the RFID tag assembly 30 by methods known in the art.

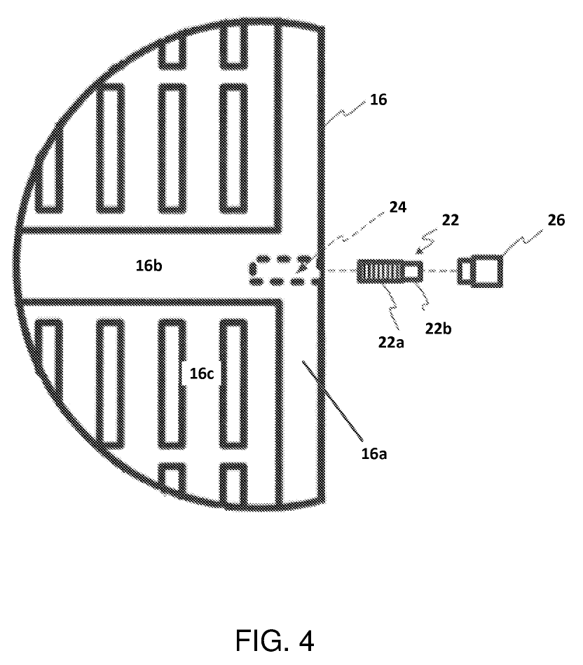

Referring now to FIG. 4, the RFID tag 22 of one of the screen panels 16 is shown removed from the screen panel 16 for purposes of illustration, according to another embodiment of the invention. The screen panel 16 may be pre-formed and may include a recess or cavity 24 formed in an edge thereof for receiving at least a portion of the RFID tag 22 or the RFID tag assembly 30. For example, the recess 24 may have a size and a shape that accommodate an antenna portion 22a of the RFID tag 22 while a chip portion 22b of the RFID tag may protrude from the recess 24. In an alternative embodiment of the screen panel 16, the recess 24 may have a size and a shape that accommodate the entire RFID tag 22. A cap 26 may cover the RFID tag 22 and may be securely affixed to the screen panel 16, typically at the outlet of the recess, such as by friction fit, snap fit, or threaded engagement within the recess 24. The cap may be configured to close an outlet defined by the recess 24. The cap 26 may further be affixed to the outlet. Alternatively, in lieu of a discrete cap 26, the RFID tag 22 may be disposed in the recess 24 and may be coated or otherwise covered with urethane, epoxy or other suitable insulating material to seal the RFID tag within the recess. The RFID tag 22 may be encased in urethane, to form the RFID tag assembly 30 and placed in a recess 24 in a known location in the screen panel 16, and typically away from any metal portions of the panel to minimize any metallic noise.

As described previously, the RFID tag 22 and or the RFID tag assembly 30 is typically installed in a portion of the screen panel 16 that is less likely to experience significant wear relative to other portions of the screen panel 16. For example, in the non-limiting embodiment shown in FIG. 1, the RFID tag 22 is installed in a longitudinal edge of the screen panel 16 equidistant from the lateral edges of the screen panel 16 and thus shielded from larger pieces of coal that are vibrated on the top surface of the screen panel 16 during dewatering processes. Thus, for embodiments in which a cap 26 is used, the cap 26 may be protected from being damaged or dislodged, thereby reducing the likelihood that water and/or particulate will be allowed to enter the recess 24 where they could damage or disable the RFID tag 22. For the embodiments in which the RFID tag 22 or the RFID tag assembly 30 is embedded in the screen panel, the screen panel itself protects the RFID tag 22 or the RFID tag assembly 30.

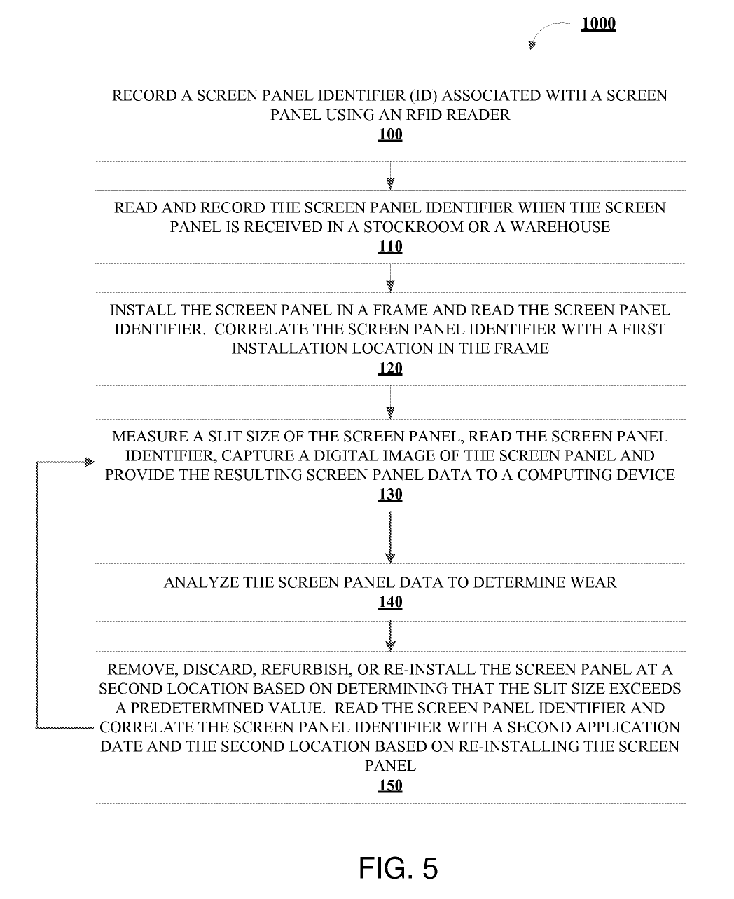

Referring to FIG. 5, a flow diagram illustrating an exemplary method and high level process flow 1000, for tracking and monitoring wear of one of the screen panels 16 during its useful lifespan in accordance with the present disclosure is shown. The method will be described in conjunction with the screen assembly shown in FIG. 1 for ease of illustration, however, this method is applicable for the other embodiments of the invention.

At step 100 of the exemplary method, a user or an automated system may use an RFID reader device to scan the RFID tag 22 of a screen panel 16 to obtain a unique identifier (hereinafter “the ID”) that is stored in the RFID tag 22. The seller may enter the ID into a database along with the date (hereinafter “the sell date”) in which the reading is performed. Such an entry may be generated automatically upon reading the RFID tag 22, such as by appropriately-configured software.

Having a record of the sell date of the screen panel 16 may be useful for a number of reasons. For example, if the end user makes a warranty claim on the screen panel 16 due to premature failure, the seller or other warrantor of the screen panel 16 may read the ID from the RFID tag 22, may reference the previously-recorded sell date associated with the ID, and may determine whether the warranty claim falls within a predetermined warranty period that extends from the sell date.

At step 110 of the exemplary method, the end user may read the ID of the screen panel 16 when the screen panel 16 is received in the end user's stockroom or warehouse where the screen panel 16 may be stored for a period of time before it is used. The reading may be performed manually, such as by an individual carrying a portable RFID reader device, or automatically, such as by an RFID reader device installed at a fixed location within the warehouse. The end user may enter the ID into a database along with the date (hereinafter “the stock date”) on which the reading is performed. Such an entry may be generated automatically upon reading the RFID tag 22, such as by appropriately-configured software.

The stock date may subsequently be used to determine how long the screen panel 16 has been lying in storage. This information can be useful, since the screen panel 16 may deteriorate over time even if not used. The end user may therefore use the stock date to determine a “use-by” date for the screen panel 16.

At step 120 of the exemplary method, the end user may install the screen panel in a first application for which the screen panel 16 is suitable (e.g., based on the dimensions of the screen panel 16 and the size of the slots 20) and, upon so doing, may read the ID of the screen panel 16. The reading may be performed manually, such as by an individual carrying a portable RFID reader device, or automatically, such as by an RFID reader device installed at a fixed location proximate the first application. The ID may be entered into a database along with the name and/or location of the first application and the date (hereinafter “the first application date”) on which the installation is performed. Again, the entry may be generated automatically upon reading the RFID tag 22.

At step 130 of the exemplary method, the end user may periodically measure the size of one or more of the slots 20 in the screen panel 16, such as according to a predetermined schedule (e.g., once every week, once every month, etc.). A first such measurement may be performed concurrently with the installation of the screen panel 16 in the first application. The measurements may be performed using various analogue and/or digital measurement devices that will be familiar to those of ordinary skill in the art. In this regard, measurement techniques/devices such as illuminated peak scale, portable illuminated microscope, taper gauge and the like may be used alone or in conjunction with an image measuring/calibrating software. The end user may also take photographs of the slots 20, such as with a digital camera, and such photographs may be manually or automatically analyzed (e.g., with appropriately configured software) to verify that the recorded measurements are correct. In this regard, the image measuring/calibrating software may be manually calibrated for every image and then the spans over the slots/apertures may be obtained as an automated response from the software. In one embodiment, a digital camera with Bluetooth and/or other wireless transmission capability is employed to take a digital image of the panel 16 and slots, and the digital image can be wirelessly transmitted to a user computing device, such as a tablet, smartphone or portable computer. The measurements and photographs may be correlated with the ID of the screen panel 16 and the dates (hereinafter “the test dates”) on which the measurements and photographs are taken. In one non-limiting embodiment, all of the aforementioned data may be stored in a memory of the computing device.

At step 140 of the exemplary method, the data collected in step 130 may be manually or automatically analyzed to make various determinations regarding the accumulation of wear on the particular screen panel 16. For example, the digital image taken of the panel and the slots can be used to verify the accuracy of the manual measurements of slot size. Further the measurements of the slots 20 on successive dates can be used to derive a “wear rate” for the screen panel 16. In this regard the wear rate may be correlated with number of tons of process substances that were filtered. Such a wear rate can then be used to forecast when the slots 20 will likely become large enough that the screen panel 16 is no longer suitable for the particular application in which it is installed. For example, the projected utilization life may be determined to be 10,000 tons of process substance. Finally, the sizes of the slots 20 can be compared to a predetermined maximum slot size to determine if the slots are approaching or have met this predetermined maximum size, thereby requiring replacement of the panel 16. The end user is therefore able to replace the screen panel 16 at a next inspection evolution, thereby maximizing the useful life of the screen panel 16 in the first application while avoiding reductions in yield that could otherwise result from slot enlargement beyond an acceptable size. The user may also determine process underflows and process overflows for every screen panel and may undertake one or more actions like increasing the moisture in the process substance, increase or decrease feed to a particular panel, vary the size of particles in the feed and the like.

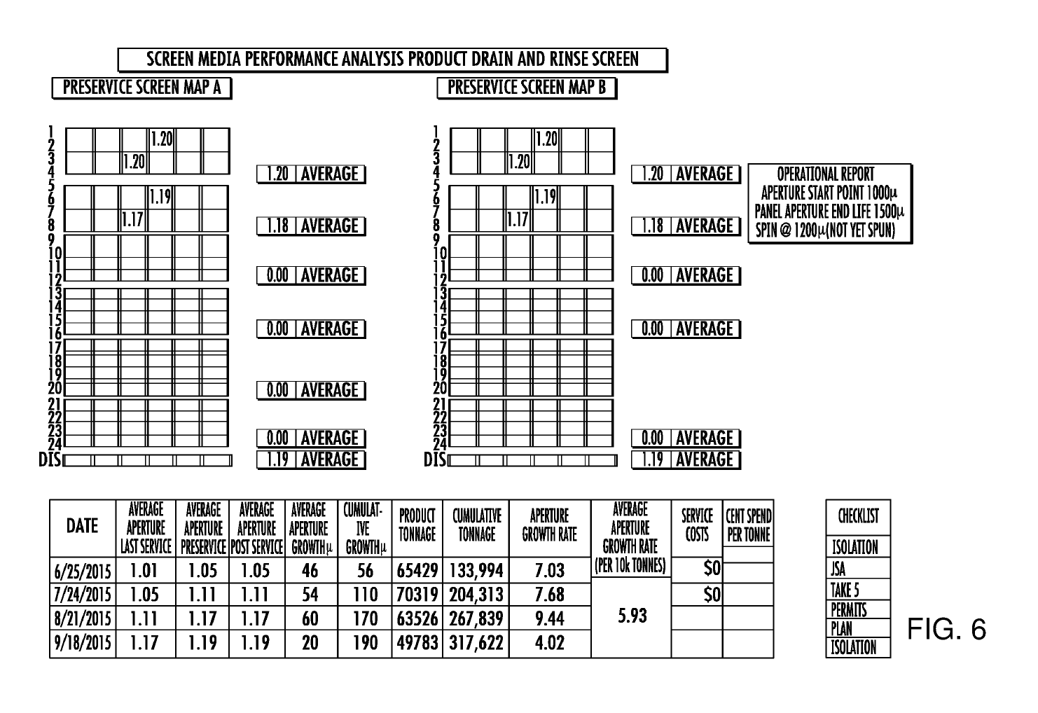

The analysis performed in step 140 may be combined with similar analyses performed on data related to other screen panels in the first application to generate a report and/or a map illustrating the relative amount of accumulated wear on all of the screen panels in the first application. A non-limiting example of such a map is shown in FIG. 6.

After the screen panel 16 has reached the end of its useful life in the first application (e.g., as determined by the analysis performed in step 140), the end user may, at step 150 of the exemplary method, remove the screen panel and discard or refurbish it, or may install the screen panel in a second application for which the screen panel 16 is suitable (e.g., based on the dimensions of the screen panel 16 and the size of the slots 20), typically, by moving the screen panel from a first location to a second location within a processing plant or system. That is, while the accumulation of wear on the screen panel 16 may have caused the slots 20 to have become enlarged beyond an acceptable size for use in the first application, the end user may determine that the slots 20 may nonetheless be of an acceptable size for use in the second application.

Upon installation of the screen panel 16 in the second application, the ID of the screen panel 16 may be manually or automatically read and may be entered into a database along with the name and/or location of the second application and the date (hereinafter “the second application date”) on which the installation is performed. Again, the entry may be generated automatically upon reading the RFID tag 22.

Steps 130-150 of the exemplary method may be repeated and the screen panel 16 may continue to be used in successive applications until the screen panel 16 is no longer suitable for use in any of the end user's applications. As described above the unique sequenced number of the RFID tag 22 is correlated with the data recording software. The first recording of data may include the panel description, material and date of manufacture. From there the information will may be recorded and expanded to reveal the life cycle of product through calibrated image capturing and grid placement. Furthermore, the method described above enables real-time tracking of a large number of screens as the screens are moved to various locations to be used in successive applications.

FIG. 6 shows an exemplary “Screen Media Performance Analysis Product Drain and Rinse Screen,” which includes a “Pre Service Screen Map A” and a “Post Service Screen Map B.” Slot size readings are identified on icons representing each panel 16 in a particular screen assembly 10, with average values identified per assembly. An average size value is also provided for each assembly 10. An “Operational Report” is also provided which identifies “Aperture Start Point (1000 microns (μ),” and “Panel Aperture End Life (1800 microns (μ).” Additional table entries include “Average Aperture Last Service,” “Average Aperture Pre Service,” “Average Aperture Post Service,” Cumulative Growth (μ),” “Product Tonnage,” “Micronic Growth Rate per 10 kP/T,” “Service Cost,” and “Cost Spent per Product Ton.” All of these values may be automatically populated to the table, by date, for use in planning service evolutions.

As will be appreciated, the disclosed system and method ensures tracking of individual screen panels 16 over their life cycle, and hence a comprehensive report can be obtained. Employing RFID tags 22 for each panel 16 is a positive way of identifying a particular asset. One example is enabling the panel manufacturer and the panel user to identify how long a panel has been sitting in stock prior to installation in a screen assembly 10. Such tracking can lead to resolution of a downstream performance issues.

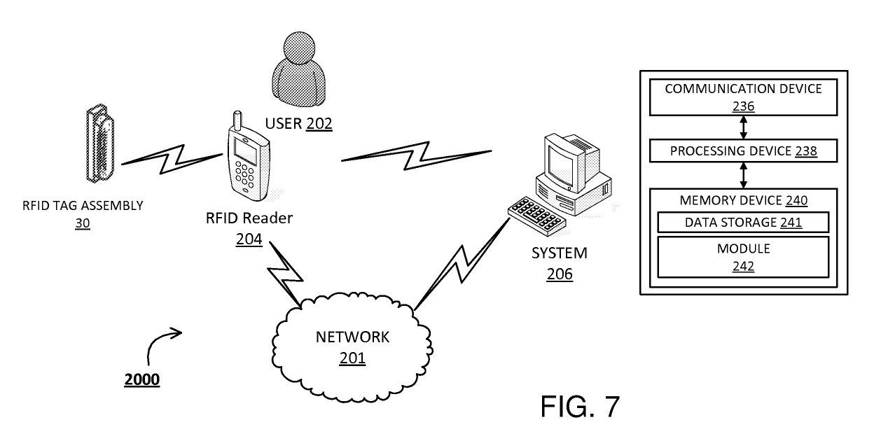

FIG. 7 illustrates a system environment for the embodiments described above. The system environment comprises a screen panel wear monitoring and forecasting system 206. The system 206 typically includes a communication device 236, a processing device 238, and a memory device 240. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

Typically, the processing device 238 is operatively coupled to the communication device 236 and the memory device 240. The processing device 238 uses the communication device 236 to communicate with the RFID reader 204 or other devices, either directly or in a network 201. As such, the communication device 236 generally comprises a modem, server, or other device for communicating with other devices on the network 201. The network 201 may be a system specific distributive network receiving and distributing specific network feeds and identifying specific network associated triggers. The network 201 may also be a global area network (GAN), such as the Internet, a wide area network (WAN), a local area network (LAN), a telecommunication network, Near Field Communication network or any other type of network or combination of networks. The network 201 may provide for wireline, wireless, or a combination wireline and wireless communication between devices on the network 201.

As further illustrated in FIG. 7, the system 206 comprises a module 242 stored in the memory device 240, which in one embodiment includes computer-readable instructions for performing one or more steps of the high level process flow 1000 for tracking and monitoring wear of the screen panels during their useful lifespan. In some embodiments, the memory device 240 includes data storage 241 (for example, a database or data repository) for storing compiled information regarding the screen panel. The compiled information may include a measured size of a slot in the screen panel, a date upon which the measured size was taken, and a digital image of the screen panel.

By the way of example, a user 202 may record a unique screen panel identifier associated with a screen panel using an RFID reader 204, the unique screen panel identifier being stored in a RFID tag of an RFID tag assembly 30 being embedded, at least partially, in the screen panel. The RFID reader 204 may transmit the received unique screen panel identifier to the system 206 either directly or via the network 201. The user 202 may further provide one or more operational parameters of the screen panel to the system 206 (e.g., by using the RFID reader 204 or another computing device). The one or more operational parameters may be slot size measurements, location of the screen panel within a processing plant, date of installation, images of the screen panel and the like. The module 242 of the system 206 may correlate the unique screen panel identifier with an installation location of the screen panel. The module 242 may further analyze the operational parameters received in the user along with compiled data already stored in the data storage 241. The module 242 may then determine wear of the screen panel, predict a life span of the screen, or the like. The module 242 may then provide the determined parameters on a Screen Media Performance Analysis Product Drain and Rinse Screen to the user 202 via a suitable interface, for example, an audio visual interface on a user device, such as a computing device, a mobile device, a tablet computer, a personal digital assistant or the like. In some embodiments, based on the wear and predicted life span, the module 242 may automatically provide one or more recommendations to the user regarding the operation of the screen panel, such as whether to remove, discard, refurbish, or reinstall the screen panel at a alternate location. The user 202 may then choose to remove, discard, refurbish, or reinstall the screen panel at a second location in the processing plant based on the determined parameters.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, a software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While the present invention has been disclosed with reference to certain embodiments, numerous modifications, alterations and changes to the described embodiments are possible without departing from the sphere and scope of the present invention, as defined in the appended claim(s). Accordingly, it is intended that the present invention not be limited to the described embodiments, but that it has the full scope defined by the language of the following claims, and equivalents thereof.

Although specific embodiments have been illustrated and described herein, those of ordinary skill in the art appreciate that any arrangement which is calculated to achieve the same purpose may be substituted for the specific embodiments shown and that the embodiments herein have other applications in other environments. This application is intended to cover any adaptations, combinations or variations of the embodiments and elements described in the present disclosure. The following claims are in no way intended to limit the scope of the disclosure to the specific embodiments described herein. While the foregoing is directed to embodiments of a system and method for screen panel tracking, other and further embodiments may be devised without departing from the basic scope thereof, and the scope thereof is determined by the claims that follow.

1. An apparatus for screen panel tracking and wear monitoring, comprising:
a screen panel, the screen panel comprising a plurality of slots, formed therethrough that ex end between a top surface and a bottom surface of the screen panel; and
an RFID tag assembly, the RFID tag assembly comprising an RFID tag and a first insulating material that completely encapsulates the RFID tag, wherein the RFID tag assembly is at least partially embedded within the screen panel, wherein the RFID tag comprises a unique screen panel identifier associated with the screen panel.

2. The apparatus of claim 1, wherein the screen panel comprises a second insulating material, wherein the RFID tag assembly is completely encapsulated within the second insulating material.

3. The apparatus of claim 2 wherein the first insulating material and the second insulating material are formed from the same material.

4. The apparatus of claim 1, wherein the RFID tag assembly is configured to withstand a temperature of at least about 140 degrees Celsius.

5. The apparatus of claim 1, wherein the first insulating material is a polymer.

6. The apparatus of claim 5, wherein the first insulating material is polyurethane.

7. The apparatus of claim 1, wherein the RFID tag is disposed within a recess formed in an edge of the screen panel, the edge being disposed between the top and bottom surfaces, wherein the screen panel further comprises a cap, the cap being fixed to an outlet defined by the recess.

8. The apparatus of claim 1, further comprising a frame defining an aperture, wherein the screen panel is disposed within the aperture.

9. A system for monitoring and forecasting wear one a screen assembly, comprising:
the apparatus of claim 1;
an analysis system comprising:
a memory;
a processor;
database stored the memory the database including compiled information regarding the screen panel, the compiled information including a measured size of a slot in the screen panel, a date upon which the measured size was taken, and a digital image of the screen panel; and
a module stored in the memory, executable by the processor and configured to: (i) receive the unique screen panel identifier associated with the screen panel and (ii) correlate the compiled information with the unique screen panel identifier associated with the screen panel.

10. A method for manufacturing an apparatus for screen panel tracking and wear monitoring, the method comprising:
providing an RFID tag, wherein the wherein the RFID tag is configured to store a unique screen panel identifier associated with a screen panel;
encapsulating the RFID tag with a first insulating material such that the first insulating material completely encapsulates the RFID tag, wherein the RFID tug and the first insulating material define a RFID tag assembly; and
disposing the RFID tag assembly within the screen panel such that the RFID tag assembly is at least partially embedded within the screen panel, wherein the screen panel comprises a plurality of slots formed therethrough that extend between a top surface and a bottom surface of the screen panel.

11. The method of claim 10, wherein encapsulating the RFID tag with the first insulating material further comprises:
providing a first mold;
disposing the RFID tag within the first mold;
pouring the first insulating material into the first mold such that the first insulating material completely encapsulates the RFID tag; and
extracting the RFID tag assembly from the first mold.

12. The method of claim 10, wherein disposing the RFID tag assembly within the screen panel further comprises:
providing a second mold configured to mold at least a portion of the screen panel; disposing the RFID tag assembly in an interior of the second mold; bonding at least a portion of a surface of the RFID tag assembly and the interior of the second mold; and
pouring a second insulating material into the told to produce the screen panel, such that the RFID tag assembly is at least partially embedded within the second insulating material.

13. The method of claim 10, wherein disposing the RFID tag assembly within the screen panel further comprises:
providing the screen panel;
providing a recess on an edge of the screen panel, the edge being between the top and bottom surfaces;
disposing the RFID tag assembly within the recess such that at least a portion of the RFID tag assembly is embedded in the screen panel;
providing a cap; and
affixing the cap to an outlet defined by the recess.

14. A method for monitoring and forecasting wear on a screen panel, the method comprising providing a screen panel, the screen panel comprising an RFID tag assembly that includes an RFID tag encapsulated in a first insulating material, wherein the RFID tag assembly is at least partially embedded within the screen panel, wherein a unique screen panel identifier associated with the screen panel is stored in the RFID tag;
determining a measurement of a size of a slot in the screen panel; reading the unique screen panel identifier stored in the RFID tag; recording the unique screen panel identifier, the measurement, and a date on which the measurement is determined in a database of information; and
analyzing the database of information to make a determination relating to an operational lifespan of the screen panel.

15. The method of claim 14, the method further comprising moving the screen panel from a first location to a second location in a processing plant based on making the determination relating to the operational lifespan of the screen panel.

16. The method of claim 14, the method further comprising discarding the screen panel based on making the determination relating to the operational lifespan of the screen panel.
